(19) United States
(12) Patent Application Publication
(10) Pub. No.: US 2001/0043114 A1
(43) Pub. Date: Nov. 22, 2001

(54) VOLTAGE BOOSTING CIRCUIT INCLUDING CAPACITOR WITH REDUCED PARASITIC CAPACITANCE

(76) Inventor: GORAN MARNFELDT, LUND (SE)

Correspondence Address: WILLIAM E BOOTH, FISH & RICHARDSON, 225 FRANKLIN STREET, BOSTON, MA, 02110

(21) Appl. No.: 09/297,867

(22) PCT Filed: May 30, 1999
(86) PCT No.: PCT/SE99/00536

§ 371 Date: None

(30) Foreign Application Priority Data
Mar. 30, 1998 (SE) 9801118-2

(51) Int. Cl. G05F 3/02

(52) U.S. Cl. 327/536

(57) ABSTRACT

A capacitor structure for an integrated circuit, the structure including a main capacitor and a parasitic capacitor, comprising: a substrate 2000 of a first conductivity type; a first dielectric layer 2040; a first conductive layer 2010 disposed over the first dielectric layer 2040, said first conductive layer 2010 forming a first plate of the main capacitor and a first plate of the parasitic capacitor; a second dielectric layer 2020 disposed over the first conductive layer 2010; and a second conductive layer 2030 disposed over the second dielectric layer 2020, the second conductive layer 2030 forming a second plate of the main capacitor; characterized in that the capacitor structure further comprises a well 2100 disposed within the substrate 2000 which is of a second conductivity type opposite to said first type, the first dielectric layer 2040 is disposed over the well 2100 and the well 2100 forms a second plate of the parasitic capacitor and a further, junction capacitor with the substrate 2000, the configuration being such that the parasitic and junction capacitors are mutually in series and in series with the main capacitor such as to reduce stray capacitance.

The present invention relates to a capacitor structure, and to a voltage boosting circuit using such a structure, as well to the application of the voltage boosting circuit to an inhaler, a mobile phone and a portable computer.

A common problem with capacitors formed in integrated circuits is the presence of stray capacitance between the plates of the capacitor and other conductors. It would be desirable to reduce this stray capacitance.

Accordingly, the present invention provides a capacitor structure for an integrated circuit, the structure including a main capacitor and a parasitic capacitor, comprising: a substrate of a first conductivity type; a first dielectric layer; a first conductive layer disposed over the first dielectric layer, the first conductive layer forming a first plate of the main capacitor and a first plate of the parasitic capacitor; a second dielectric layer disposed over the first conductive layer; and a second conductive layer disposed over the second dielectric layer, the second conductive layer forming a second plate of the main capacitor; characterised in that the capacitor structure further comprises a well disposed within the substrate which is of a second conductivity type opposite to said first type, the first dielectric layer is disposed over the well and the well forms a second plate of the parasitic capacitor and a further, junction capacitor with the substrate, the configuration being such that the parasitic and junction capacitors are mutually in series and in series with the main capacitor such as to reduce stray capacitance.

The present invention also provides a method of boosting a voltage source, comprising the steps of: providing the above-described capacitor structure; charging the first plate of the main capacitor thereof relative to the second plate of the main capacitor; and subsequently charging the second plate relative to the first plate to provide a boosted voltage at the first plate.

The present invention further provides a voltage boosting circuit, comprising: the above-described capacitor structure; charging means configured to operate in first and second modes; and an output node for providing a boosted voltage; wherein in a first mode of operation the first plate of the main capacitor is connected to a first voltage and the second plate of the main capacitor is connected to a second voltage and in the second mode of operation the first plate is connected to a second voltage and the second plate is connected to the output node.

A preferred embodiment of the present invention will now be described hereinbelow by way of example only with reference to the accompanying drawings, in which:

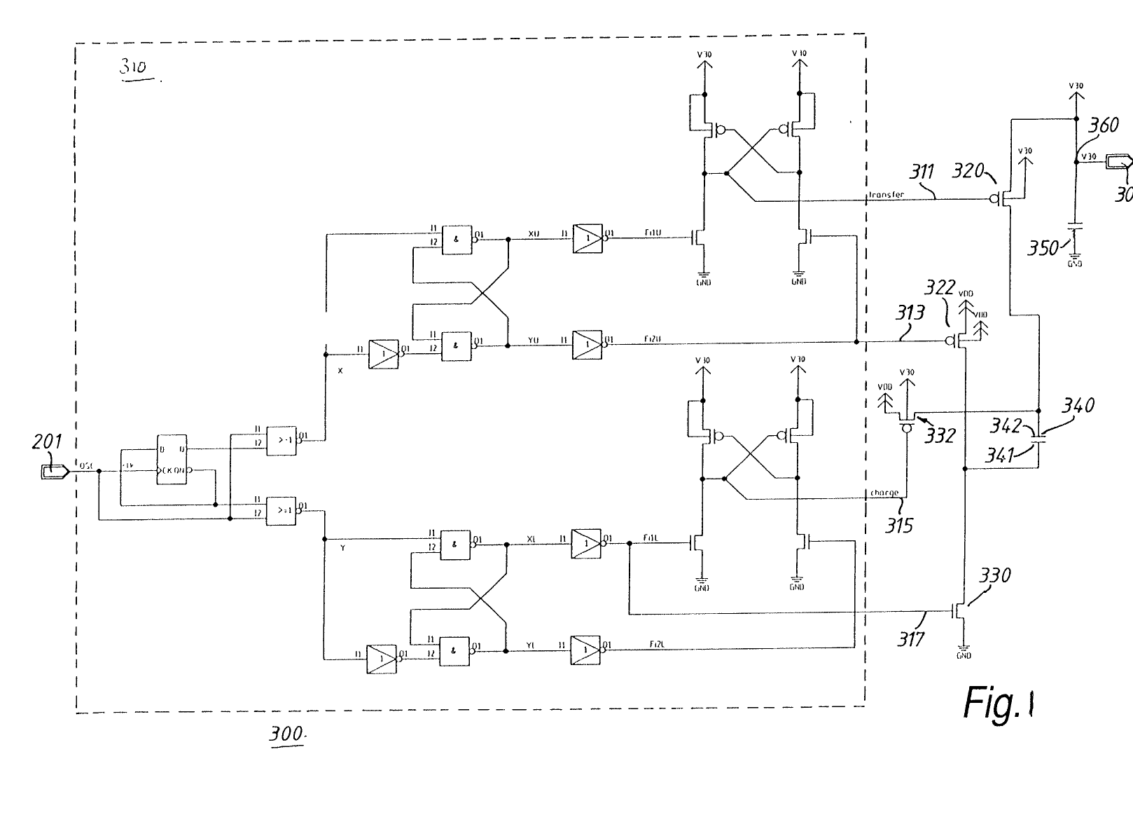

FIG. 1 illustrates a voltage booster 300;

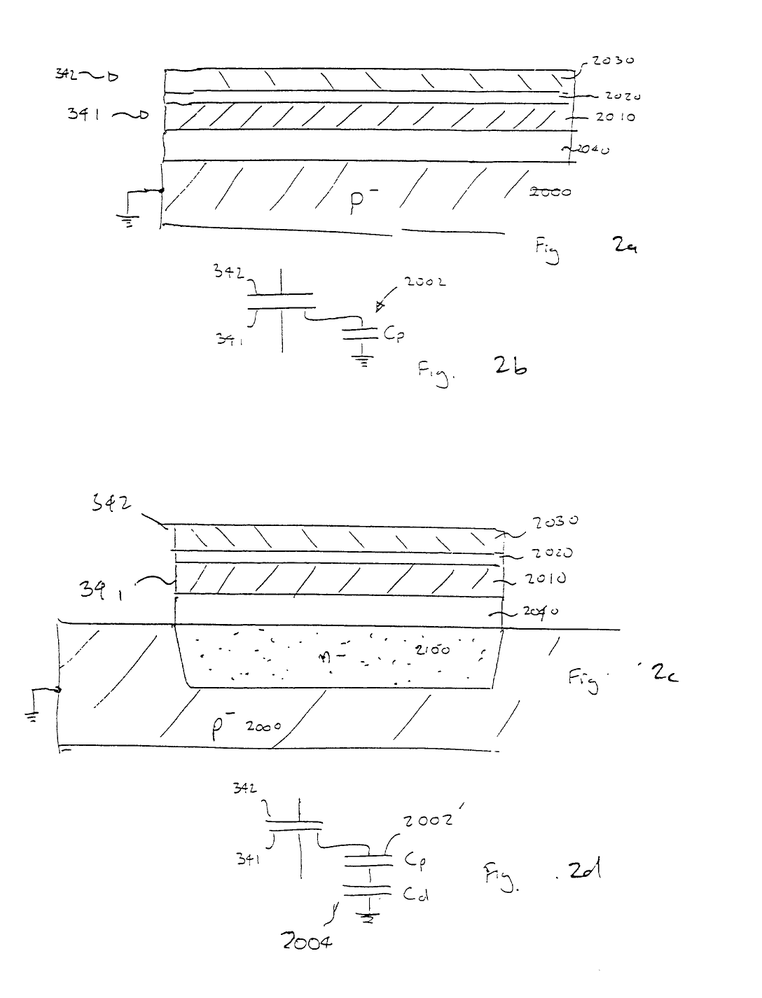

FIG. 2a and 2b illustrate a first capacitor;

FIGS. 2c and 2d illustrate a second capacitor; and

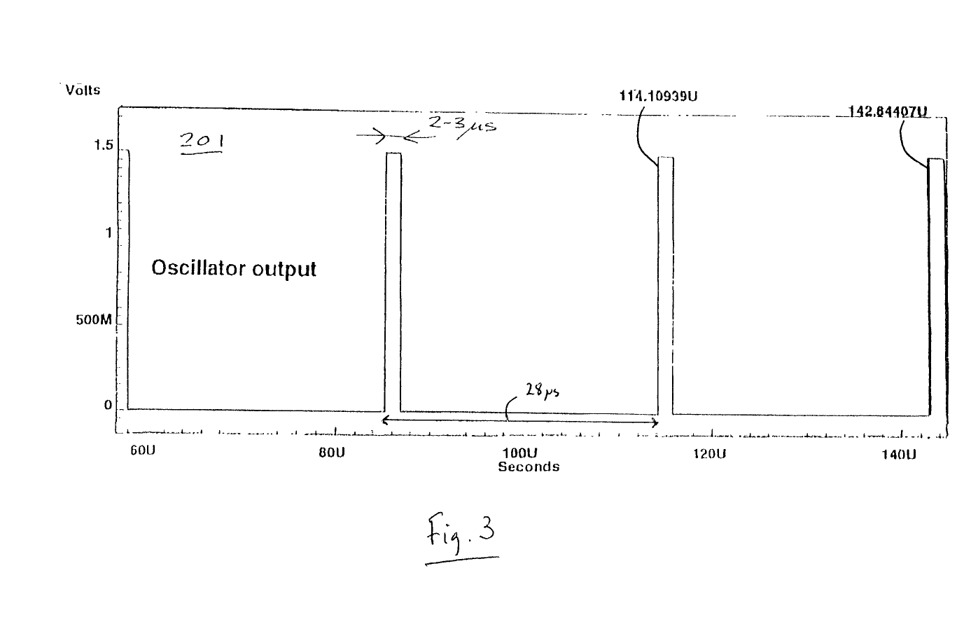

FIG. 3 illustrates the output signal 201.

Referring to FIG. 1, a voltage booster 300 is illustrated. The voltage booster 300 is connected to a supply voltage Vdd of 1.5 V and produces at an output node a voltage V30 of 3 V. The voltage booster 300 has logic circuitry 310 for converting an input clock signal 201 into output signals 311, 313, 315 and 317. The clock signal 207 is illustrated in FIG. 3. It is a pulsed signal which is generally low but which has high pulses of approximately 2 to 3 μs with a periodicity of 28 μs (frequency of 33 kHz). Signals 311 and 313 are synchronous clock signals. Signals 315 and 317 are synchronous clock signals in anti-phase to the signals 311 and 313. The frequency of the clock signals 311 to 317 is the same as the input clock signal 201. The circuitry 310 ensures that the signals 315 and 317 do not overlap the signals 311 and 313. A p-channel field effect transistor 322 is connected as a switch between a positive voltage supply and a first plate 341 of a capacitor 340. The gate of the p-channel transistor 322 receives the output signal 313. The first plate 341 of the capacitor 340 is also connected to ground via an n-channel transistor 330 which operates as a switch. The gate of the n-channel transistor 330 is connected to the signal 317. A second plate 342 of the capacitor 340 is connected to a positive voltage Vdd via a p-channel transistor 332 which operates as a switch. The gate of the p-channel transistor 332 is connected to the signal 315. The second plate of the capacitor 342 is also connected to an output node 360 of the voltage booster 300 via a p-channel transistor 320 which acts as a switch. The gate of the p-channel transistor 320 is connected to the signal 311. The output node 360 of the booster circuit 300 is connected via a capacitor 350 to ground. The output node 360 provides the output signal 301. In the first phase of operation, the transistors 332 and 330 are switched on via the synchronous signals 315 and 317. The transistors 322 and 320 are simultaneously switched off by the synchronous signals 311 and 313. During this phase of operation the second plate 342 of the capacitor 340 is charged to a positive potential relative to the first plate 341. During a second phase of operation, the transistors 332 and 330 are switched off by the synchronous signals 315 and 317 and the transistors 322 and 320 are simultaneously switched on by the synchronous signals 311 and 313. In this phase of operation the first plate 341 of the capacitor 340 is raised to approximately the voltage Vdd which raises the voltage at the second plate 342 of the capacitor 340 to approximately twice the voltage Vdd. The transistor 320 allows the thus boosted voltage at the second plate of the capacitor 340 to be presented at the output node 360 as the output signal 301 from the booster circuit 300. The output signal 301 simultaneously charges the capacitor 350. When this phase of operation finishes and the first phase again begins the transistor 320 is switched off isolating the capacitor 350 which has been charged to the boosted voltage value. The boosted voltage value V30 is therefore continuously presented at the output node 360.

The capacitor 340 is illustrated in more detail in FIGS. 2a, 2b, 2c and 2d. A conventional capacitor is illustrated in FIG. 2a and its equivalent circuit diagram in FIG. 2b. The capacitor is formed over a p-doped silicon substrate 2000. A dielectric layer 2040 separates the first plate of the capacitor 341, formed from a layer of polysilicon 2010, from the substrate 2000. A thin dielectric layer 2020 separates the second capacitor plate 342, formed from a second polysilicon layer 2030, from the first polysilicon layer 2010. As illustrated in FIG. 2b, a parasitic capacitor 2002 having a value Cp is formed between the first plate of the capacitor and the grounded silicon substrate 2000. During the operation of the booster circuit 300 this parasitic capacitance may result in power loss.

The capacitor illustrated in FIG. 2c is devised to reduce power loss and finds particular application in the booster circuit 300 as capacitor 340. Referring to FIG. 2c the capacitor structure differs from FIG. 2a in that an n-type well 2100 has been formed in the p-substrate 2000. The layers 2040, 2010, 2020 and 2030 are formed over the well 2100. These layers do not extend beyond the dimensions of the well in this example. The n-type well forms a reverse biased pn junction diode with the p-type substrate. Such a diode has a low capacitance. FIG. 2d illustrates a schematic equivalent circuit of the structure illustrated in FIG. 2c. The diode forms a small capacitor 2004 with small capacitance Cd in series with the parasitic capacitor 2002′ having a capacitance Cp, formed between the first plate 341 and the n-type well 2100. The combined capacitance of the capacitors 2002′ and 2004 is less than Cd and less than Cp.

Finally, it will be understood that the present invention has been described in its preferred embodiment and can be modified in many different ways within the scope of the appended claims.

1. A capacitor structure for an integrated circuit, the structure including a main capacitor and a parasitic capacitor, comprising:
a substrate 2000 of a first conductivity type;
a first dielectric layer 2040;
a first conductive layer 2010 disposed over the first dielectric layer 2040, the first conductive layer 2010 forming a first plate of the main capacitor and a first plate of the parasitic capacitor;
a second dielectric layer 2020 disposed over the first conductive layer 2010; and
a second conductive layer 2030 disposed over the second dielectric layer 2020, the second conductive layer 2030 forming a second plate of the main capacitor; characterised in that the capacitor structure further comprises a well 2100 disposed within the substrate 2000 which is of a second conductivity type opposite to said first type, the first dielectric layer 2040 is disposed over the well 2100 and the well 2100 forms a second plate of the parasitic capacitor and a further, junction capacitor with the substrate 2000, the configuration being such that the parasitic and junction capacitors are mutually in series and in series with the main capacitor such as to reduce stray capacitance.

2. A capacitor as claimed in claim 1, wherein said first conductivity type is p-type and the second conductivity type is n-type.

3. A method of boosting a voltage source, comprising the steps of:
providing a capacitor structure as claimed in claim 1 or 2;
charging the first plate of the main capacitor thereof relative to the second plate of the main capacitor; and
subsequently charging the second plate relative to the first plate to provide a boosted voltage at the first plate.

4. A voltage boosting circuit, comprising:
a capacitor structure as claimed in claim 1 or 2;
charging means configured to operate in first and second modes; and
an output node for providing a boosted voltage;
wherein in a first mode of operation the first plate of the main capacitor is connected to a first voltage and the second plate of the main capacitor is connected to a second voltage and in the second mode of operation the first plate is connected to a second voltage and the second plate is connected to the output node.

5. A voltage boosting circuit as claimed in claim 4, wherein the first voltage is ground and the second voltage is a positive voltage.

6. A voltage boosting circuit as claimed in claim 4 or 5, wherein the first plate is connected via a first switch to the second voltage and through a second switch to the first voltage and the first and second switches are arranged to operate in anti-phase.

7. A voltage boosting circuit as claimed in any of claims 4 to 6, wherein the second plate is connected via a third switch to the output node and via a fourth switch to the first voltage and the third and fourth switches operate in anti-phase.

8. A voltage boosting circuit as claimed in claim 7 when dependent upon claim 6, wherein the first and third switches are p-channel FETs and the second and fourth switches are p and n-channel FETs.

9. A voltage boosting circuit as claimed in any of claims 4 to 8, further comprising a second capacitor connected between the output node and the first voltage.

10. An inhaler including a voltage boosting circuit as claimed in any of claims 4 to 9.

11. A mobile phone including a voltage boosting circuit as claimed in any of claims 4 to 9.

12. A portable computer including a voltage boosting circuit as claimed in any of claims 4 to 9.
